(19) United States
(12) Patent Application Publication
(10) Pub. No.: US 2021/0118048 A1
(43) Pub. Date: Apr. 22, 2021

(54) Determining Credit Risk of an Online Merchant Based on Performance of Goods/Services of the Merchant in an Online Marketplace

(71) Applicants: Alejandro Correa Bahnsen, Bogota (CO); Matias Ruiz Vesga, Bogota (CO); Rafael Casabianca Iregui, Bogota (CO)

(72) Inventors: Alejandro Correa Bahnsen, Bogota (CO); Matias Ruiz Vesga, Bogota (CO); Rafael Casabianca Iregui, Bogota (CO)

(21) Appl. No.: 16/596,284

(22) Filed: Oct. 8, 2019

(51) Int. Cl. G06Q 40/02; G06Q 30/02

(52) U.S. Cl. CPC G06Q 40/025; G06Q 30/0282

(57) ABSTRACT

Methods and systems to compute credit worthiness of an online merchant from results of keyword searches for items of the merchant in an online marketplace. Measures of performance (e.g., popularity/consumer feedback) of the items are determined from the search results, and the credit worthiness is computed from the measures of performance. The credit worthiness may be computed from an average star rating of the items, a percentage of the items that are identified as best-selling items, total a number of items that appear in the search results, a number of reviews associated with items in a predetermined number of pages of the search results, and/or rankings of the merchant items based on relative positions of the items within the search results. A word score may be computed from a subset of the measures of performance, and the credit worthiness may be computed from the word score.

### BACKGROUND

Online merchants sell items on e-commerce platforms, or online marketplaces, such as Amazon.com. An online merchant may seek a loan to fund operations (e.g., product development/manufacture), with the intent of paying off the loan with sale proceeds.

In order to mitigate the impact of credit risk and make objective and accurate decisions, financial institutions use credit scores to predict and control losses. The objective in credit scoring is to classify which potential customers are likely to default a contracted financial obligation based on the customer's past financial experience, and with that information decide whether to approve or decline a loan. Credit scoring has become standard practice among financial institutions around the world in order to predict and control loans portfolios.

Conventional credit scoring algorithms use a variety of factors related to a loan applicant (e.g., income, credit payment history, and the like), or factors related to a pool of loans. What are needed are techniques to consider factors related to performance of items of a merchant in an online marketplace, such as popularity of the items.

### BRIEF DESCRIPTION OF THE DRAWINGS/FIGURES

FIG. 1 is a flowchart of a method of computing financial credit worthiness of an online merchant based on performance (e.g., popularity/purchaser feedback) of items of the online merchant.

FIG. 2 is an image of search results of an online marketplace for the keywords “computer speakers.”

FIG. 3 is a flowchart of a method of computing financial credit worthiness of an online merchant based in part on word scores computed from measures of performance of items of the online merchant.

FIG. 4 is an image of search results of an online marketplace for the keyword “speaker.”

FIG. 5 is a process flowchart of a method of training a model to compute a measure of financial credit worthiness of an online merchant based on measures of performance of items of the online merchant in an online marketplace.

FIG. 6 is a block diagram of a computer system configured to compute a measure of financial credit worthiness of an online merchant based on performance of items of the merchant in an online marketplace.

In the drawings, the leftmost digit(s) of a reference number identifies the drawing in which the reference number first appears.

### DETAILED DESCRIPTION

Online marketplaces present unique opportunities for lenders to consider performance information (e.g., popularity/purchaser feedback) of items (i.e., goods and/or services) of a merchant. Examples are provided below for illustrative purposes. Methods and systems disclosed herein are not, however, limited to the following examples.

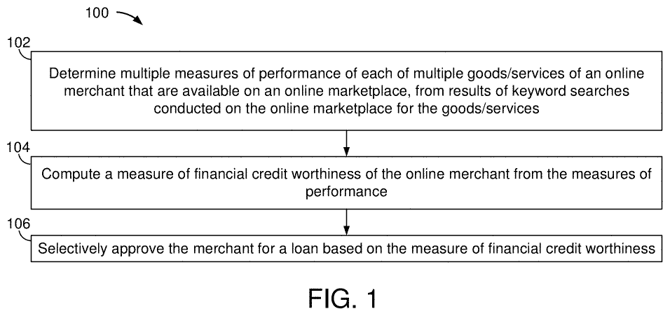

FIG. 1 is a flowchart of a method 100 of computing financial credit worthiness of a merchant based on performance of items of the merchant in an online marketplace.

At 102, multiple measures of performance are determined for one or more items of an online merchant. The measures of performance may be determined from results of keyword searches conducted on an online marketplace for the respective items. Examples are provided below with respect to audio speakers for a computer (i.e., Creative Pebble speakers).

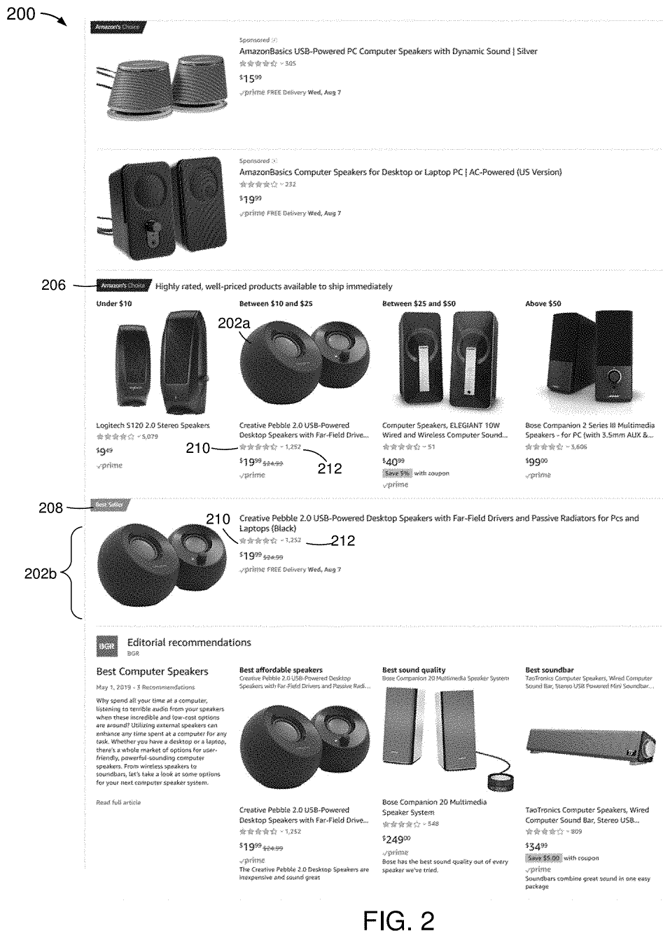

FIG. 2 is an image of search results 200 presented when the keywords “computer speakers” are submitted in a query to online marketplace Amazon.com. Search results 200 include Creative Pebble speakers (speakers) 202 in FIG. 2 (two instances, 202a and 202b). One or more of a variety of features of search results 200 may be indicative of a performance of speakers 202. Such indications of performance may be useful in computing financial credit worthiness of a merchant of speakers 202.

Search results 200 include an Amazon Choice badge 206 associated with speakers 202s. According to Amazon.com, the Amazon Choice badge indicates that an item is highly rated, well-priced, and available to ship immediately. Amazon Choice badge 206 may help to convince a user to choose speakers 202 over other speakers. Amazon Choice badge 206 may thus serve as a measure of performance of speakers 202.

Search results 200 further include a Best Seller badge 208 associated with speakers 202b. Best Seller badge 208 may help to convince a user to choose speakers 202 over other speakers. Best Seller badge 208 may thus serve as a measure of performance of speakers 202.

Search results 200 further include an average star rating 210 associated with speakers 202. Average star rating 210 represents an average number of stars assigned by reviewers (e.g., purchasers) of speakers 202. A relatively high average stars rating 210 may help to convince a user to choose speakers 202 over other speakers. Average star rating 210 may thus serve as a measure of performance of speakers 202.

Search results 200 further include a number of reviewers 212 who assigned stars to speakers 202. The number of reviewers 212, alone or in combination with average star rating 210, may help to convince a user to choose speakers 202 over other speakers. The number of reviewers 212 may thus serve as a measure of performance of speakers 202.

An online marketplace may order items of a search result based on one or more of a variety of factors (e.g., relevance to keywords used in the search, pricing, past sales volume, and/or other factor(s)). The position of speakers 202 within search results 200, relative to other items in search results 200, may thus serve as a measure of performance of speakers 202.

In the examples above, the measures of performance are specific to the items of the online merchant. Other measures of performance may be determined for a class of items. Examples are provided below.

The performance of a class of items may be relevant to the performance of the items of a merchant. For example, a relatively high number of speakers within search results 200 may be indicative of a relatively high performance of speakers in the online marketplace. The number of items that appear in search results 200 may thus serve as an indirect measure of performance of speakers 202.

As another example, a relatively high number of number of reviews of items within search results 200 may be indicative of a relatively high performance of speakers in the online marketplace. The number of reviews that appear in search results 200 may thus serve as an indirect measure of performance of speakers 202.

The foregoing examples describe performance measures that are detectable/observable within search results 200. One or more other measures of performance may be inferred or computed from such observable performance measures. Examples are provided further below with respect to word scores, item scores, and merchant scores.

In FIG. 1, the determining at 102 may include performing keyword searches on an online marketplace and extracting/scraping performance information from results of the keyword searches. Alternatively, performance information may be provided by an analytics platform that scrapes information from results of keyword searches of others. Example analytics platforms include, without limitation, MerchantWords, marketed by by MerchantWords, LLC, of Los Angeles, Calif.

At 104, a measure of financial credit worthiness of the merchant is computed from the measures of performance. The measure of financial credit worthiness may be computed solely from the measures of performance, or from a combination of the measures of performance and other credit risk factors. Example other credit risk factors are provided further below with reference to Table 1.

In an embodiment, the computing at 104 includes computing the measure of financial credit worthiness from:
the average star ratings of the items of the online merchant;
a percentage of the items of the online merchant that are identified as best-selling items in the online marketplace;
the total number of items that appear in the results of the keyword searches of the respective items;
the total number of reviews associated with items that appear in the results of the keyword searches; and/or
rankings of the items of the online merchant, based on locations of the items in the respective search results relative to other items.

At 106, the online merchant is approved for or denied a loan based on the measure of financial credit worthiness.

Users of online marketplaces often do not go past the first page, or the first few pages of search results. Thus, the determining at 102 and/or the computing at 104 may be performed with respect to a predetermined portion of search results (e.g., the first page, the first two pages, the first three pages, etc.).

The determining at 102 and/or the computing at 104 may be performed with respect to a predetermined number of items of the merchant (e.g., the top five best selling items of the merchant).

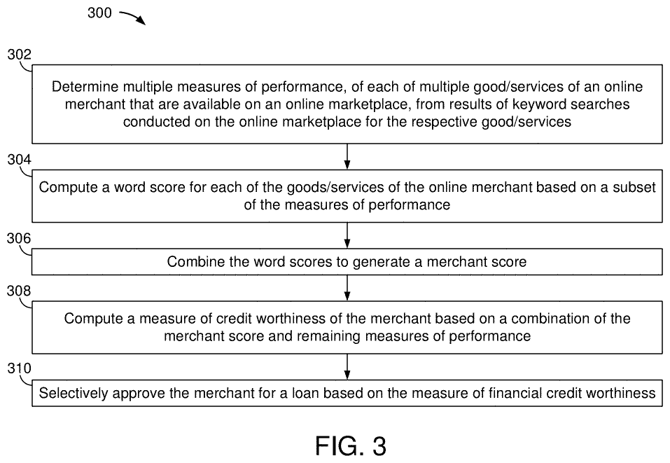

The computing at 104 may include computing a word score for each of the items of the online merchant based on a subset of the measures of performance determined at 102, and computing the financial credit worthiness based on a combination of the word scores and remaining measures of performance determined at 102. Examples are provided below with reference to FIG. 3.

FIG. 3 is a flowchart of a method 300 of computing financial credit worthiness of an online merchant based in part on word scores computed from measures of performance of items of the online merchant.

At 302, multiple measures of performance are determined for items of the online merchant, such as described above with respect to 102 in FIG. 1.

A 304, a word score is computed from results of each keyword search for an item of the online merchant. Each word score may be computed from a subset of measures of performance determined from results of the respective keyword search. The word score may be computed from class-based measures of performance. For example, a word score may be computed from:
the number of reviews that appear in results of the keyword search;
the number of items that appear in the results of the keyword searches; and
the rank of the respective item based on a location of the item within the results of the keyword search.

In an embodiment, the word score is computed from results of a keyword search as:

$$\frac{1}{rank} * i ( reviews ) * j ( results ) ,$$

where,
rank is based on a location of the respective item within results of a key word search,
reviews is the number of reviews that appear in the results of the keyword search,
results is the number of items that appear in the results of the keyword search, and
i and j are weighting or scaling factors.

In an embodiment, i=log₅₀₀ and j=log₁₀.

At 306, the word scores are combined to provide a merchant score. Examples are described below.

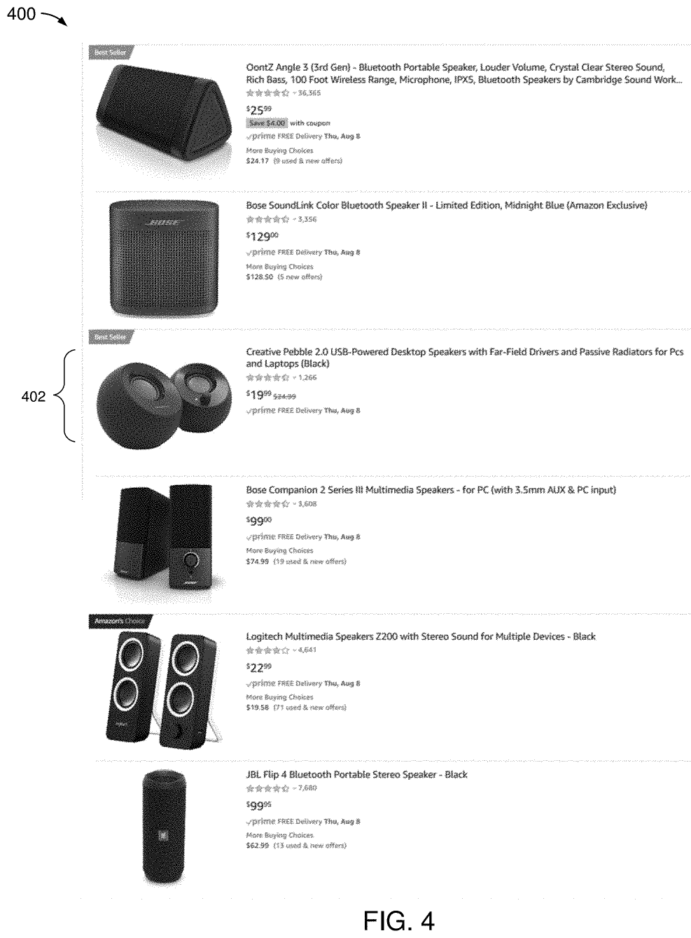

An item of a merchant may be found in an online marketplace with more than one keyword search. For example, FIG. 4 is an image of search results 400 from online marketplace Amazon.com for the keyword “speaker.” As with search results 200 in FIG. 2 (based on keywords “computer speakers”), search results 400 include Creative Pebble speakers 402. Search results 400 may, however, differ from search results 200 in other respects, such as rank, reviews, and/or results. Where results of multiple keyword searches are available for an item of an online merchant, method 100 and/or method 300 may be performed with respect to results of the multiple keyword searches.

For example, multiple word scores may be computed for an item of a merchant, each based on a results of a respective keyword search. Multiple word scores of an item may be combined (e.g., summed), to provide a score for the item (i.e., an item score). The item scores for multiple goods/services of the merchant may be combined (e.g., summed), to provide the merchant score.

As an example, a merchant score may be computed as:

$${\sum }_{ASIN} {\sum }_{KW} \frac{1}{Rank} * i ( reviews ) * j ( results )$$

$$where , \\ {\sum }_{KW} represents summation of word scores of each item ( i . e . , item score ) , and$$

$${\sum }_{ASIN} represents summation of the item scores .$$

Word scores, items scores, and merchant scores may be referred to herein as measures of performance.

At 308, a measure of financial credit worthiness of the online merchant is computed from the merchant score, and remaining measures of performance determined at 302 (e.g., average star ratings of the items of the online merchant and percentage of items of the online merchant deemed best sellers).

The measure of financial credit worthiness may be computed from the word score and the remaining measures of performance, alone or in combination with other credit risk factors. Example other risk factors are described further below with reference to Table 1.

At 310, the online merchant is approved for or denied a loan based on the measure of financial credit worthiness.

The measure of financial credit worthiness computed at 104 and/or 308 may be computed with a cost-insensitive binary classification algorithm such as logistic regression, neural networks, discriminant analysis, genetic programing, decision trees, and/or other(s). The measure of financial credit worthiness may, for example, be computed with a statistical model to estimate a probability \hat{ }pi=P(yi=1|xi) of a merchant i defaulting a proposed loan. In this example, an objective is to estimate a classifier ci to decide whether to grant a loan to a customer i. A threshold t may be defined such that, if \hat{ }pi<t, the loan is approved (i.e., ci(t)=0), and denied otherwise (i.e., ci(t)=1). Methods and systems disclosed herein are not, however, limited to binary classification techniques.

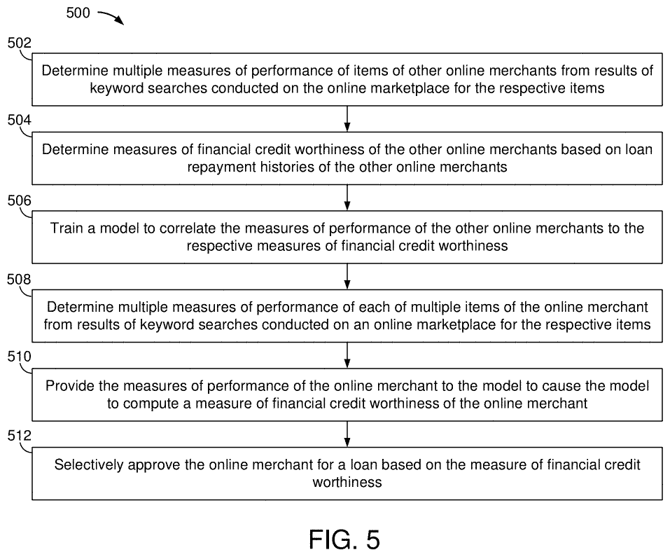

In an embodiment, a statistical model is trained to compute the measure of financial credit worthiness of the online merchant, such as described below with reference to FIG. 5.

FIG. 5 is a process flowchart of a method 500 of training a model to compute a measure of financial credit worthiness of an online merchant based on measures of performance of items of the online merchant.

At 502, measures of performance are determined for items of other online merchants, such as described in one or more examples herein.

At 504, measures of financial credit worthiness of the other online merchants are determined (e.g., based on loan repayment histories of the other online merchants).

At 506, a model is trained to correlate the measures of performance of items of the other online merchants to the measures of financial credit worthiness of the respective other online merchants (i.e., trained to “predict” the measures of financial credit worthiness of the other online merchants from the measures of performance of items of the other online merchants).

The training at 506 may utilize a random forest classifier algorithm. Random forests or random decision forests are an ensemble learning method for classification, regression, and other tasks that operates by constructing a multitude of decision trees at training time and outputting the class that is the mode of the classes (classification) or mean prediction (regression) of the individual trees.

At 508, the measures of performance are determined for items of the online merchant, such as described in one or more examples herein.

At 510, the measures of performance of the online merchant are provided to the model to cause the model to compute/output a measure of financial credit worthiness of the online merchant.

At 512, the online merchant is approved for or denied a loan based on the measure of financial credit worthiness

In an embodiment, the model is trained at 508 to correlate the measures of performance and other loan consideration factors related to the other online merchants, to the measures of financial credit worthiness of the other online merchants. In this example, at 510, the measures of performance of the online merchant and other loan consideration factors related to first online merchant, are provided to the model to cause the model to compute/output the measure of financial credit worthiness of the first online merchant.

Other loan consideration/risk factors, referred to in one or more foregoing examples, may include one or more variables listed in Table 1, below. Other factors are not, however, limited to the example of Table 1.

TABLE 1

| Variable | Description |
|---|---|
| Applicant Details | Type of applicant, years as a client, subscribed |
| | products, etc. |
| Credit Product | When a dataset contains different products |
| Job Details | Years on the job, job seniority, job title, etc. |
| Income | Employment income, housing income, other |
| | income, financial assets, etc. |
| Interest Rate | Interest rate of the proposed loan |
| Age | Age of the applicant |
| Economic Activity | Working field |
| Score | Scores provided by underwriters |
| Credit History | Credit Payment History |
| Loan Term | Term of the proposed loan |
| Housing Details | House type, ownership, housing costs, etc. |
| Geography | Postal code, city, region, etc. |
| Consumption Behavior | Living costs, expenses, withdrawals, etc. |
| Nationality | Nationality of the applicant |

Additional other factors are provided in Current Expected Credit Loss (CECL) accounting standards issued by the Financial Accounting Standards Board (FASB) on Jun. 16, 2016. CECL provides factors to consider with respect to commercial loans. CECL also stipulates that banks shall measure credit losses of financial assets on a collective (i.e., pool) basis when similar risk characteristic(s) exist. The risk factors include:
Internal or external (3^{rd} party) credit score or credit ratings;
Risk ratings of classification;
Financial asset type;
Collateral type;
Size;
Effective interest rate;
Term;
Geographic location;
Industry of the borrower;
Vintage;
Historical or expected credit loss patterns; and
Reasonable and supportable forecast periods.

Methods and systems disclosed herein may be useful to intrinsically assign a market value to an inventory of an online merchant according to the keyword scores of the items of the merchant (e.g., for two inventories of the same face value, the one having a higher keyword score may be assigned a higher valuation).

One or more features disclosed herein may be implemented in, without limitation, circuitry, a machine, a computer system, a processor and memory, a computer program encoded within a computer-readable medium, and/or combinations thereof. Circuitry may include discrete and/or integrated circuitry, application specific integrated circuitry (ASIC), a system-on-a-chip (SOC), and combinations thereof.

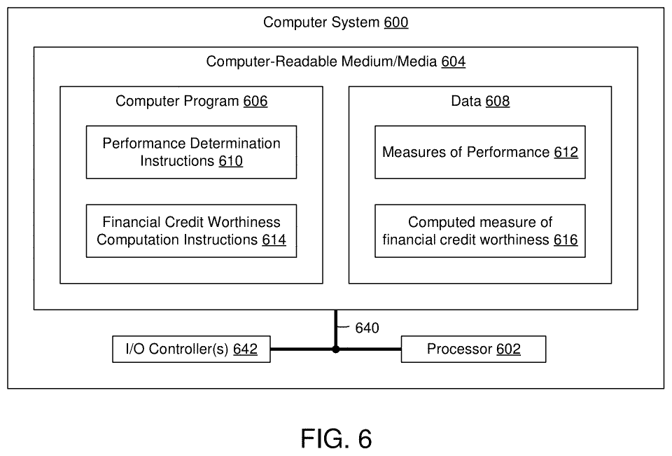

FIG. 6 is a block diagram of a computer system 600, configured to compute a measure of financial credit worthiness of an online merchant based on performance of items of the merchant in an online marketplace.

Computer system 600 includes one or more instruction processors, illustrated here as a processor 602, to execute instructions of a computer program 606 encoded within a computer-readable medium 604. Computer-readable medium 604 further includes data 608, which may be used by processor 602 during execution of computer program 606, and/or generated by processor 602 during execution of computer program 606.

Computer-readable medium 604 may include a transitory or non-transitory computer-readable medium.

In the example of FIG. 6, computer program 606 includes performance determination instructions 610 to cause processor 602 to determine multiple measures of performance 612 for one or more items of an online merchant, such as described in one or more examples above.

Computer program 606 further includes financial credit worthiness computation instructions 614 to cause processor 602 to compute a measure of financial credit worthiness of the online merchant, such as described in one or more examples above.

Computer program 606 may further include model training instructions to cause processor 602 to train a model to compute the measure of financial credit worthiness, such as described in one or more examples above. In this example, financial credit worthiness computation instructions 614 include instructions to cause processor 602 to compute the measure of financial credit worthiness in accordance with the trained model.

Computer system 600 further includes communications infrastructure 640 to communicate amongst devices and/or resources of computer system 600.

Computer system 600 further includes one or more input/output (I/O) devices and/or controllers 642 to interface with one or more other systems, such as a human interface device(s).

Methods and systems are disclosed herein with the aid of functional building blocks illustrating functions, features, and relationships thereof. At least some of the boundaries of these functional building blocks have been arbitrarily defined herein for the convenience of the description. Alternate boundaries may be defined so long as the specified functions and relationships thereof are appropriately performed. While various embodiments are disclosed herein, it should be understood that they are presented as examples. The scope of the claims should not be limited by any of the example embodiments disclosed herein.

What is claimed is:

1. A method, comprising:
determining multiple measures of performance, of each of multiple items of a merchant that are available on an online marketplace, from results of key word searches conducted on the online marketplace for the respective items; and
computing a measure of financial credit worthiness of the merchant from the measures of performance.

2. The method of claim 1, wherein the computing includes:
computing the measure of financial credit worthiness based on,
an average of star ratings of the multiple items of the merchant,
a percentage of the multiple items of the merchant that are identified as best-selling items in the results of the respective keyword searches,
a number of items that appear in the results of the keyword searches,
a number of reviews associated with items shown in a predetermined number of pages of the results of the keyword searches, and/or
rankings of the multiple items of the merchant, wherein each ranking is based on a location of a respective one or the multiple items of the merchant within the results of the respective keyword search relative to other items in the results.

3. The method of claim 1, wherein the computing includes:
computing a word score for each of the key word searches based on,
a number of reviews that appear in a predetermined number of pages of the results of the keyword search,
a number of items that appear in the results of the keyword search, and
a rank corresponding to a location of the item within the results of the key word search;
combining the word scores to provide a merchant score; and
computing the measure of financial credit worthiness of the merchant from the merchant score, an average of star ratings of the multiple items of the merchant, and a percentage of the multiple items of the merchant that are identified as best-selling items in the results of the keyword searches.

4. The method of claim 3, wherein the computing a word score includes, for each of the multiple items of the merchant:
$$computing \frac{1}{rank} * i ( reviews ) * j ( results ) ,$$
where,
rank is the rank corresponding to the location of the item within the results of the key word search,
reviews is the number of reviews that appear in the predetermined number of pages of the results of the keyword search,
results is the number of items that appear in the results of the keyword search, and
i and j are weighting factors.

5. The method of claim 4, wherein:
i=log₅₀₀; and
j=log₁₀.

6. The method of claim 3, wherein the combining the word scores to provide a merchant score includes:
summing the word scores to provide the merchant score.

7. The method of claim 1, further including:
determining the multiple measures of performance of items of other merchants from results of key word searches conducted on the online marketplace for the items of the other merchants;
determining measures of financial credit worthiness of the other merchants based on loan repayment histories of the other merchants; and
training a model to correlate the multiple measures of performance of the items of the other merchants to the measures of financial credit worthiness of the other merchants;
wherein the computing a measure of financial credit worthiness of the merchant includes providing the multiple measures of performance of the multiple items of the merchant to the model to cause the model to compute the measure of financial credit worthiness of the merchant.

8. An apparatus, comprising, a processor and memory configured to:
determine multiple measures of performance, of each of multiple items of a merchant that are available on an online marketplace, from results of key word searches conducted on the online marketplace for the respective items; and
compute a measure of financial credit worthiness of the merchant from the measures of performance.

9. The apparatus of claim 8, wherein the processor and memory are further configured to:
compute the measure of financial credit worthiness based on,
an average of star ratings of the multiple items of the merchant,
a percentage of the multiple items of the merchant that are identified as best-selling items in the results of the respective keyword searches,
a number of items that appear in the results of the keyword searches,
a number of reviews associated with items shown in a predetermined number of pages of the results of the keyword searches, and/or
rankings of the multiple items of the merchant, wherein each ranking is based on a location of a respective one or the multiple items of the merchant within the results of the respective keyword search relative to other items in the results.

10. The apparatus of claim 8, wherein the processor and memory are further configured to:
compute a word score for each of the key word searches based on,
a number of reviews that appear in a predetermined number of pages of the results of the keyword search,
a number of items that appear in the results of the keyword search, and
a rank corresponding to a location of the item within the results of the key word search;
combine the word scores to provide a merchant score; and
compute the measure of financial credit worthiness of the merchant from the merchant score, an average of star ratings of the multiple items of the merchant, and a percentage of the multiple items of the merchant that are identified as best-selling items in the results of the keyword searches.

11. The apparatus of claim 10, wherein the processor and memory are further configured to compute the word score for each of the multiple items of the merchant as:
$$\frac{1}{rank} * i ( reviews ) * j ( results ) ,$$
wherein,
rank is the rank corresponding to the location of the item within the results of the key word search,
reviews is the number of reviews that appear in the predetermined number of pages of the results of the keyword search,
results is the number of items that appear in the results of the keyword search, and
i and j are weighting factors.

12. The apparatus of claim 11, wherein:
i=log₅₀₀; and
j=log₁₀.

13. The apparatus of claim 10, wherein the processor and memory are further configured to sum the word scores to provide the merchant score.

14. The apparatus of claim 8, wherein the processor and memory are further configured to:
determine the multiple measures of performance of items of other merchants from results of key word searches conducted on the online marketplace for the items of the other merchants;
determine measures of financial credit worthiness of the other merchants based on loan repayment histories of the other merchants;
train a model to correlate the multiple measures of performance of the items of the other merchants to the measures of financial credit worthiness of the other merchants; and
provide the multiple measures of performance of the multiple items of the merchant to the model to cause the model to compute the measure of financial credit worthiness of the merchant.

15. A non-transitory computer readable medium encoded with a computer program that includes instructions to cause a processor to:
determine multiple measures of performance, of each of multiple items of a merchant that are available on an online marketplace, from results of key word searches conducted on the online marketplace for the respective items; and
compute a measure of financial credit worthiness of the merchant from the measures of performance.

16. The non-transitory computer-readable medium of claim 15, further including instructions to cause the processor to:
compute the measure of financial credit worthiness based on,
an average of star ratings of the multiple items of the merchant,
a percentage of the multiple items of the merchant that are identified as best-selling items in the results of the respective keyword searches,
a number of items that appear in the results of the keyword searches,
a number of reviews associated with items shown in a predetermined number of pages of the results of the keyword searches, and/or
rankings of the multiple items of the merchant, wherein each ranking is based on a location of a respective one or the multiple items of the merchant within the results of the respective keyword search relative to other items in the results.

17. The non-transitory computer-readable medium of claim 15, further including instructions to cause the processor to:
compute a word score for each of the key word searches based on,
a number of reviews that appear in a predetermined number of pages of the results of the keyword search,
a number of items that appear in the results of the keyword search, and
a rank corresponding to a location of the item within the results of the key word search;
combine the word scores to provide a merchant score; and
compute the measure of financial credit worthiness of the merchant from the merchant score, an average of star ratings of the multiple items of the merchant, and a percentage of the multiple items of the merchant that are identified as best-selling items in the results of the keyword searches.

18. The non-transitory computer-readable medium of claim 17, further including instructions to cause the processor to compute the word score for each of the multiple items of the merchant as:
$$\frac{1}{rank} * i ( reviews ) * j ( results ) ,$$
wherein,
rank is the rank corresponding to the location of the item within the results of the key word search,
reviews is the number of reviews that appear in the predetermined number of pages of the results of the keyword search,
results is the number of items that appear in the results of the keyword search, and
i and j are weighting factors.

19. The non-transitory computer-readable medium of claim 17, further including instructions to cause the processor to sum the word scores to provide the merchant score.

20. The non-transitory computer-readable medium of claim 15, further including instructions to cause the processor to:
determine the multiple measures of performance of items of other merchants from results of key word searches conducted on the online marketplace for the items of the other merchants;
determine measures of financial credit worthiness of the other merchants based on loan repayment histories of the other merchants;
train a model to correlate the multiple measures of performance of the items of the other merchants to the measures of financial credit worthiness of the other merchants; and
provide the multiple measures of performance of the multiple items of the merchant to the model to cause the model to compute the measure of financial credit worthiness of the merchant.
